(19) United States
(12) Patent Application Publication
(10) Pub. No.: US 2024/0213574 A1
(43) Pub. Date: Jun. 27, 2024

(54) POWER STORAGE DEVICE

(71) Applicant: TOYOTA JIDOSHA KABUSHIKI KAISHA, Toyota-shi (JP)

(72) Inventors: Nobuyasu Nishiki, Toyokawa-shi (JP); Naofumi Nomura, Nagakute-shi (JP); Masaki Shimada, Kariya-shi (JP); Kazuaki Okudaira, Miyoshi-shi (JP); Sakuya Uchiyama, Toyota-shi (JP)

(73) Assignee: TOYOTA JIDOSHA KABUSHIKI KAISHA, Toyota-shi (JP)

(21) Appl. No.: 18/466,971

(22) Filed: Sep. 14, 2023

(30) Foreign Application Priority Data
Dec. 21, 2022 (JP) 2022-204511

(51) Int. Cl. H01M 10/6554; H01M 10/658

(52) U.S. Cl. CPC H01M 10/6554; H01M 10/658; H01M 50/209

(57) ABSTRACT

A power storage device based on the present disclosure includes a plurality of power storage modules, a housing case, a plate, a shielding plate, and a heat conduction member. The power storage modules are disposed side by side along a first direction orthogonal to a vertical direction. The housing case includes an upper case and a lower case, and houses the power storage modules. The plate is disposed above the power storage modules in the housing case. The shielding plate is fixed to the plate and disposed between the power storage modules. The heat conduction member is disposed between the shielding plate and the lower case, and has a higher thermal conductivity than the shielding plate.

### CROSS-REFERENCE TO RELATED APPLICATION

This application claims priority to Japanese Patent Application No. 2022-204511 filed on Dec. 21, 2022, incorporated herein by reference in its entirety.

### BACKGROUND

### 1. Technical Field

The present disclosure relates to a power storage device.

### 2. Description of Related Art

Japanese Unexamined Patent Application Publication No. 2020-155367 (JP 2020-155367 A) discloses a conventional power storage device. The power storage device includes a plurality of power storage modules, a housing case, a plate, and a plurality of support members. The power storage modules are disposed side by side along a first direction orthogonal to a vertical direction. The housing case includes an upper case and a lower case. The housing case houses the power storage modules. The plate is disposed above the power storage modules. The plate extends along the first direction. The support members are fixed to the lower case. The support members support the plate.

### SUMMARY

In the conventional power storage device, the power storage modules are surrounded by the lower case, the plate, and the support members. Therefore, heat generated in the power storage modules is likely to be trapped in the housing case. Thus, there is a possibility that the heat generated in one of the power storage modules affects the performance of other power storage modules.

The present disclosure has been made in view of the above problem. An object of the present disclosure is to provide a power storage device capable of reducing the influence of heat generated in power storage modules on other power storage modules.

A power storage device based on the present disclosure includes a plurality of power storage modules, a housing case, a plate, a shielding plate, and a heat conduction member. The power storage modules are disposed side by side along a first direction orthogonal to a vertical direction. The housing case includes an upper case and a lower case, and houses the power storage modules. The plate is disposed above the power storage modules in the housing case. The shielding plate is fixed to the plate and disposed between the power storage modules. The heat conduction member is disposed between the shielding plate and the lower case. The heat conduction member has a higher thermal conductivity than the shielding plate.

In the power storage device based on the present disclosure, heat generated in the power storage modules is restrained from being directly transmitted to other adjacent power storage modules by the shielding plate. The heat transferred to the shielding plate is conducted to the lower case via the heat conduction member. The heat is conducted to the lower case, whereby the heat is easily dissipated to the outside of the housing case. Therefore, the heat generated in the power storage modules is restrained from being trapped in the housing case. Thus, the influence of the heat generated in power storage modules on other power storage modules can be reduced.

In the power storage device based on the present disclosure, the heat conduction member may have lower rigidity than the shielding plate. The heat conduction member may be disposed in a state of being compressed in the vertical direction. A portion of the shielding plate facing the heat conduction member side may be fixed to the lower case in a horizontal direction by a reaction force from the heat conduction member.

In the above-described power storage device, the plate positioned above the power storage modules is firmly supported by the heat conduction member and the shielding plate. When vertical vibration of the housing case (lower case) is transmitted to the shielding plate via the heat conduction member, the vibration of the housing case is attenuated in the heat conduction member due to deformation of the heat conduction member with relatively low rigidity. Thus, vibration of the shielding plate is restrained. Further, vibration of the plate positioned above the power storage modules is also restrained.

According to the present disclosure, the influence of the heat generated in power storage modules on other power storage modules can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a power storage device according to an embodiment of the present disclosure;

FIG. 2 is a partial cross-sectional view of the power storage device of FIG. 1 viewed from a II-II line arrow;

FIG. 3 is a schematic perspective view illustrating a configuration of a part of a power storage device according to the embodiment of the present disclosure; and

FIG. 4 is a schematic cross-sectional view for explaining the bending of the case of the power storage device according to the embodiment of the present disclosure.

### DETAILED DESCRIPTION OF EMBODIMENTS

Hereinafter, a power storage device according to an embodiment of the present disclosure will be described with reference to the drawings. In the following description of the embodiment, the same or corresponding parts in the drawings are denoted by the same reference numerals, and the description thereof will not be repeated.

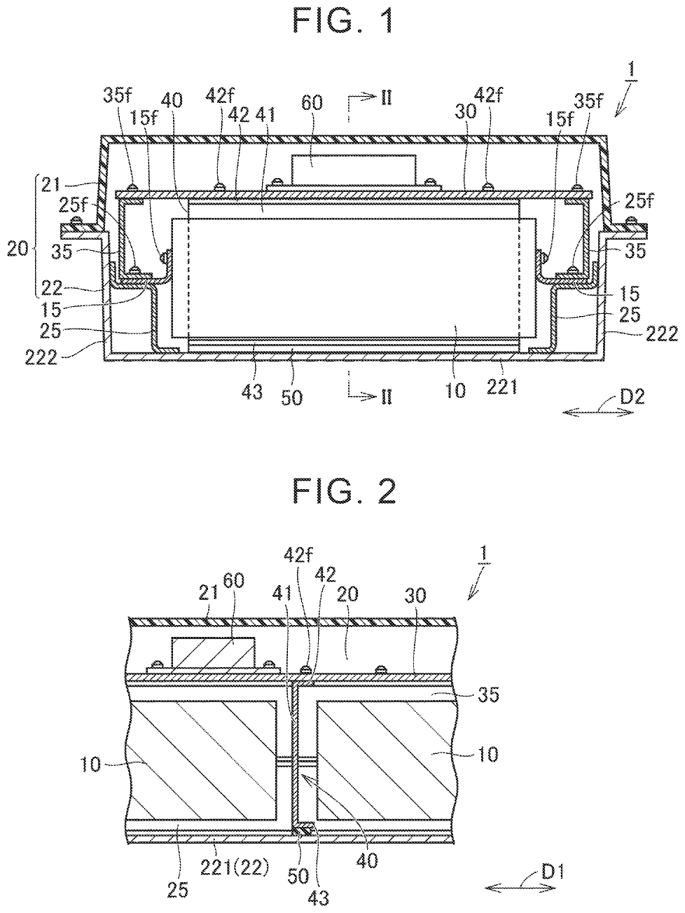

FIG. 1 is a cross-sectional view illustrating a power storage device according to the embodiment of the present disclosure. FIG. 2 is a partial cross-sectional view of the power storage device of FIG. 1 as viewed from a II-II line arrow. As illustrated in FIGS. 1 and 2, the power storage device 1 according to the present disclosure includes a plurality of power storage modules 10, a housing case 20, a plate 30, a shielding plate 40, and a heat conduction member 50.

The power storage device 1 may be mounted on a vehicle. The vehicles are, for example, battery electric vehicle. Battery electric vehicle includes an electric motor as a motor for driving the vehicle. The power storage device 1 is configured to be capable of supplying electric power to the electric motor in a state of being mounted on the vehicle.

The power storage modules 10 are disposed side by side along the first direction D1. The first direction D1 is a direction perpendicular to the up-down direction. Each of the power storage modules 10 is specifically a battery module. The battery module is configured by arranging a plurality of unit cells (not shown) side by side in the second direction. The second direction D2 is a direction perpendicular to both the up-down direction and the first direction D1. When the power storage device 1 is mounted on the vehicle, the first direction D1 is the front-rear direction of the vehicle, and the second direction D2 is the widthwise direction of the vehicle.

The unit cell is, for example, a secondary battery such as a nickel metal hydride battery or a lithium-ion battery. The unit cell has, for example, a square shape. The secondary battery may use a liquid electrolyte. In addition, the secondary battery may be one using a solid electrolyte.

The power storage device 1 further includes a plurality of brackets 15. The brackets 15 are provided on both sides of each of the power storage modules 10 in the second direction D2. The bracket 15 is provided to fix the power storage module 10 to the housing case 20.

The bracket 15 is fixed to the power storage module 10. A method of fixing the bracket 15 to the power storage module 10 is not particularly limited. In the present embodiment, the bracket 15 is fixed to the power storage module 10 by a fastening member 15f. The bracket 15 extends from the power storage module 10 toward the housing case 20. Specifically, the bracket 15 extends along the second direction D2. The bracket 15 may be directly fixed to the housing case 20. In the present embodiment, it is fixed to the housing case 20 via another member (which will be described later in detail).

The housing case 20 houses the power storage modules 10. The housing case 20 includes an upper case 21 and a lower case 22.

The upper case 21 has a substantially box shape that opens downward. The upper case 21 is made of a resin material. However, the upper case 21 may be made of a metal material.

The lower case 22 has a substantially box shape that opens upward. The lower case 22 is made of a metal material. However, the lower case 22 may be made of a resin material. The lower case 22 has a bottom portion 221 and a peripheral wall portion 222 standing from the bottom portion 221.

The opening of the upper case 21 and the opening of the lower case 22 are joined together in the vertical direction. With this configuration, the housing space of the housing case 20 is formed.

The power storage device 1 further includes a plurality of pedestal portions 25. The pedestal portions 25 are provided inside the housing case 20 (on the housing space side). Each of the pedestal portions 25 is located between the power storage module 10 and the peripheral wall portion 222 of the lower case 22 in the second direction D2. The pedestal portion 25 is fixed to the lower case 22. A method of fixing the pedestal portion 25 to the lower case 22 is not particularly limited. In the present embodiment, the pedestal portion 25 is fixed to the lower case 22 by welding. More specifically, the pedestal portion 25 is fixed to each of the bottom portion 221 and the peripheral wall portion 222 by welding.

On both sides of the power storage module 10 in the second direction D2, the bracket 15 is fixed to the pedestal portion 25. A method of fixing the bracket 15 to the pedestal portion 25 is not particularly limited. In the present embodiment, the bracket 15 is fixed to the pedestal portion 25 by the fastening member 25f. In this manner, the power storage module 10 is fixed to the lower case 22 (housing case 20) via the bracket 15 and the pedestal portion 25.

The plate 30 is disposed above the power storage modules 10 in the housing case 20. The plate 30 is disposed to provide other components above the power storage module 10. The plate 30 extends horizontally perpendicular to the up-down direction, and specifically extends in both the first direction D1 and the second direction D2. Therefore, it is preferable that the plate 30 has a relatively high rigidity in order to suppress deflection and vibration in the up-down direction.

The power storage device 1 further includes a plurality of support members 35. Each of the support members 35 is fixed to both end portions of the plate 30 in the second direction D2. The support members 35 are respectively located on both sides of the power storage module 10 in the second direction D2. The support member 35 extends downward from the plate 30 and supports the plate 30 in the housing case 20. A method of fixing the support member 35 to the plate 30 is not particularly limited. In the present embodiment, the support member 35 is fixed to the plate 30 by a fastening member 35f.

The support member 35 may be directly fixed to the housing case 20. In the present embodiment, it is fixed to the housing case 20 (lower case 22) via other members. Specifically, the support member 35 is positioned above the pedestal portion 25, and is fixed to the pedestal portion 25 on the side opposite to the plate 30 side. More specifically, the support member 35 is disposed so as to sandwich the bracket 15 together with the pedestal portion 25 in the up-down direction. The support member 35 is fixed to the pedestal portion 25 by the fastening member 25f together with the bracket 15. The method of fixing the support member 35 to the pedestal portion 25 is not limited to this. The support member 35 may be directly fixed to the pedestal portion 25 without using the bracket 15.

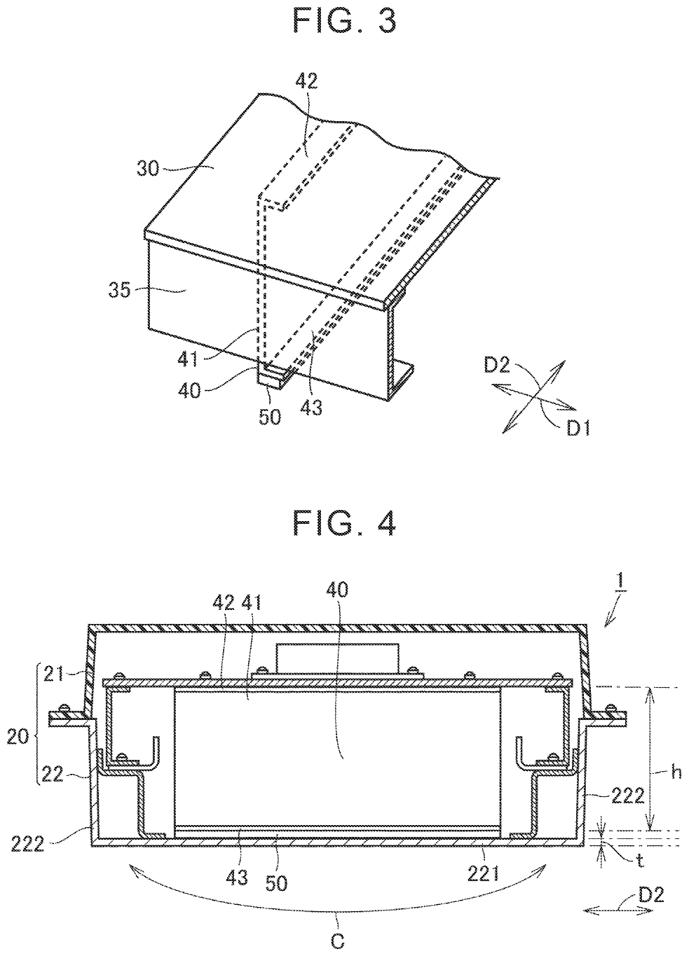

FIG. 3 is a schematic perspective view illustrating a configuration of a part of a power storage device according to the embodiment of the present disclosure. As shown in FIGS. 1 to 3, the shielding plate 40 is fixed to the plate 30. The shielding plate 40 is disposed between the power storage modules 10.

The shielding plate 40 has a wall portion 41, a top portion 42, and a pressing portion 43. The wall portion 41 extends along the up-down direction and the second direction D2.

The top portion 42 is located at an upper end portion of the wall portion 41.

The top portion 42 extends throughout the shielding plate 40 in the second direction D2. The top portion 42 extends from the wall portion 41 to one side in the first direction D1. The top portion 42 is fixed to the plate 30. The method of fixing the top portion 42 (the shielding plate 40) to the plate 30 is not particularly limited. In the present embodiment, the top portion 42 is fixed to the plate 30 by a fastening member 42f.

The pressing portion 43 is located at a lower end portion of the wall portion 41. The pressing portion 43 extends over the entire shielding plate 40 in the second direction D2. The pressing portion 43 extends from the wall portion 41 toward one side in the first direction D1. When viewed from the wall portion 41, the pressing portion 43 extends in the same direction as the top portion 42. The pressing portion 43 may extend in a direction different from that of the top portion 42 when viewed from the wall portion 41. The pressing portion 43 is spaced apart from the bottom portion 221 (the lower case 22). The pressing portion 43 presses the heat conduction member 50, which will be described later, downward.

The material constituting the shielding plate 40 is not particularly limited. The shielding plate 40 transmits heat to the heat conduction member 50. Therefore, it is preferable to use a material having a relatively high heat transfer property. For example, the shielding plate 40 is made of metal. The shielding plate 40 is specifically made of a steel plate. In addition, the shielding plate 40 preferably has high rigidity from the viewpoint of suppressing deflection of the housing case 20 described later.

The heat conduction member 50 is disposed between the pressing portion 43 (the shielding plate 40) and the bottom portion 221 (the lower case 22). Specifically, the heat conduction member 50 is in contact with the pressing portion 43 and the bottom portion 221. The heat conduction member 50 has a higher thermal conductivity than the shielding plate 40. The heat conduction member 50 is a soft sheet-like member and extends in the second direction D2 along the pressing portion 43.

The heat conduction member 50 has a lower rigidity than the shielding plate 40. The heat conduction member 50 is disposed in a state of being compressed in the up-down direction by the pressing portion 43 (the shielding plate 40) and the bottom portion 221 (the lower case 22) by being pressed by the pressing portion 43. Therefore, a portion of the shielding plate 40 facing the heat conduction member side is fixed to the bottom portion 221 (lower case 22) in the horizontal direction by the reaction force from the heat conduction member 50. That is, the pressing portion 43 is fixed to the bottom portion 221 (the lower case 22) in the horizontal direction by the reaction force from the heat conduction member 50.

The heat conduction member 50 is not particularly limited as long as it is made of a material having low rigidity and high heat conductivity. The heat conduction member 50 is, for example, a soft rubber sheet having a high thermal conductivity and a soft rubber shape.

It is also preferable that at least one of the upper surface and the lower surface of the heat conduction member 50 is an adhesive surface. As a result, the end portion (the pressing portion 43) of the shielding plate 40 can be fixed more firmly in the horizontal direction.

The power storage device 1 further includes an electronic device 60. The electronic device 60 is located above the plate 30. The electronic device 60 is fixed to the plate 30. The type of the electronic device 60 is not particularly limited. For example, the electronic device 60 may be an electronic control unit (ECU) that monitors the power storage module 10. In the present embodiment, as will be described later, even if the housing case 20 vibrates, the vibration of the plate 30 is suppressed. Therefore, the acceleration of the vibration in the electronic device 60 can be reduced.

As described above, the power storage device 1 according to the present embodiment includes the shielding plate 40 and the heat conduction member 50. The shielding plate 40 is fixed to the plate 30 and is disposed between the power storage modules 10. The heat conduction member 50 is disposed between the shielding plate 40 and the lower case 22. The heat conduction member 50 has a higher thermal conductivity than the shielding plate 40.

According to the above configuration, the shielding plate 40 suppresses the heat generated in the power storage module 10 from being directly transmitted to the other adjacent power storage modules 10. The heat transferred to the shielding plate 40 is conducted to the lower case 22 via the heat conduction member 50. Therefore, the heat transferred to the shielding plate 40 is easily dissipated to the outside of the housing case 20. Therefore, the heat generated in the power storage module 10 is prevented from being trapped in the housing case 20. In this way, the influence of the heat generated in the power storage module 10 on the other power storage modules 10 can be reduced.

In the power storage device 1, the heat conduction member 50 has a lower rigidity than the shielding plate 40. The heat conduction member 50 is disposed in a state of being compressed in the up-down direction. A portion of the shielding plate 40 facing the heat conduction member side is fixed to the lower case 22 in the horizontal direction by a reaction force from the heat conduction member 50.

According to the above configuration, the plate 30 positioned above the power storage module 10 is firmly supported by the heat conduction member 50 and the shielding plate 40. When the vertical vibration of the housing case 20 (the lower case 22) is transmitted to the shielding plate 40 via the heat conduction member 50, the vibration of the housing case 20 is attenuated in the heat conduction member 50 due to the deformation of the heat conduction member 50 having a relatively low rigidity. Thus, vibration of the shielding plate 40 is suppressed. Further, the vibration of the plate 30 located above the power storage module 10 is also suppressed.

Further, according to the above configuration, the lower case 22 and the shielding plate 40 are firmly fixed in the second direction D2. Therefore, deflection deformation of the lower case 22 (in particular, the bottom portion 221) in the up-down direction is suppressed. Deflection deformation suppression of the lower case 22 will be described below.

FIG. 4 is a schematic cross-sectional view for explaining the bending of the case of the power storage device according to the embodiment of the present disclosure. As shown in FIG. 4, for example, when the bottom portion 221 of the lower case 22 is bent along the direction of the arrow C by an external force from the outside of the power storage device 1 (that is, when an attempt is made to extend in the vertical direction), deformation of the bottom portion 221 is suppressed by the shielding plate 40 extending in the vertical direction.

The effect of suppressing deformation of the bottom portion 221 by the shielding plate 40 will be described in more detail. In general, the amount of vertical deflection of the beam-shaped member with respect to a predetermined load is approximately inversely proportional to the cube of the vertical length (thickness) of the member. Here, in the power storage device 1 according to the present embodiment, when the thickness t of the bottom portion 221 is 1.2 mm and the height h of the shielding plate 40 is 100 mm (see FIG. 4), the value of (t+h)³ is approximately 0.6 million times the value of t³. Therefore, when the shielding plate 40 is configured as described above, and the shielding plate 40 can be regarded as a substantially integral member with the bottom portion 221, it is inferred that the vertical deflection amount of the bottom portion 221 is suppressed to about 1/0.6 million as compared with the case where the shielding plate 40 is not provided.

The embodiment disclosed herein is to be considered in all respects as illustrative and not restrictive. The scope of the disclosure is represented by the appended claims, not by the above description, and includes all modifications within the meanings and scope equivalent to the claims.

What is claimed is:

1. A power storage device comprising:
a plurality of power storage modules disposed side by side along a first direction orthogonal to a vertical direction;
a housing case that includes an upper case and a lower case, and that houses the power storage modules;
a plate disposed above the power storage modules in the housing case;
a shielding plate fixed to the plate and disposed between the power storage modules; and
a heat conduction member disposed between the shielding plate and the lower case, the heat conduction member having a higher thermal conductivity than the shielding plate.

2. The power storage device according to claim 1, wherein:
the heat conduction member has lower rigidity than the shielding plate, and is disposed in a state of being compressed in the vertical direction; and
a portion of the shielding plate facing the heat conduction member side is fixed to the lower case in a horizontal direction by a reaction force from the heat conduction member.
